(19) United States
(12) Patent Application Publication
(10) Pub. No.: US 2024/0394274 A1
(43) Pub. Date: Nov. 28, 2024

(54) LEAN FRAMEWORK COMPUTING SYSTEM AND METHOD THEREFOR

(71) Applicant: Jasmeet S Ajmani, Secaucus, NJ (US)

(72) Inventor: Jasmeet S Ajmani, Secaucus, NJ (US)

(21) Appl. No.: 18/267,143

(22) PCT Filed: May 13, 2022
(86) PCT No.: PCT/US22/29138

§ 371 Date: Jun. 14, 2023

(51) Int. Cl. G06F 16/25

(52) U.S. Cl. CPC G06F 16/254

(57) ABSTRACT

A lean computational computing system including a first map reduce processor to ingest the input data sets and coding, convert the row-oriented data sets and coding into columnar-oriented data sets and coding, split up the columnar-oriented data sets and coding into a plurality of smaller units, load the split up columnar-oriented data sets and coding simultaneously in parallel, to reduce the loaded data sets and coding, and to convert the columnar-oriented data sets and coding into an object-oriented language format, and a second map reduce processor including a plurality of execution sub-processors to split up the object-oriented language into a plurality of smaller units, parallel process the plurality of smaller units of object-oriented language simultaneously, and reduce the parallel processed results into a final result according to programming included in the input coding.

### STATEMENT REGARDING FEDERALLY SPONSORED RESEARCH OR DEVELOPMENT

Not applicable.

### COPYRIGHT NOTICE

A portion of this disclosure contains material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever. 37 C.F.R 1.71 (d).

### BACKGROUND OF THE INVENTIVE CONCEPT

### 1. Field of the Invention

The present inventive concept relates to lean framework computer system to provide optimal loading and processing of data sets and coding. More particularly, but not exclusively, this inventive concept relates to a lean framework computer system to convert row-oriented data into columnar-oriented data, perform a first map reduce process on the columnar-oriented data, convert the map reduced data to object-oriented data, and perform a second map reduce process on the object-oriented data.

### Description of the Related Art

A single core processor in a computer system is used for numerous types of computational operations on vast amounts of data ingested by these computers and computing systems. Although such single core processors provide computational operations at relatively high speeds, there is a limit to how fast they can perform complex computational operations on large amounts of data since a single core processor can only ingest a certain amount of data at a time, can only store a certain amount of data into a storage space, and can only perform complex computations up to a certain rate of speed before bottle-necking.

A single core processor in a computer system generally ingests data received in a “comma separated values” (CSV) file format since such CSV files help to export a high volume of data to a more concentrated database. However, since CSV files are in the form of a row-oriented storage, one row contains multiple data types, which takes a significant amount of time to process. Further, row-oriented data files also take up a large amount of storage space.

Accordingly, there is a need for a lean framework computing system that can convert ingested data from a row-oriented format to a columnar-oriented format for efficiency of storage, faster readability, and lower latency, and to prevent computations from being bogged down with processing of data which is not relevant to the task(s) required.

There is also a need for a lean framework computing system that can split up large amounts of data into smaller units of data to load the data faster.

There is also a need from a lean framework computing system that can split up object-oriented data into smaller units and simultaneously perform computational tasks on the smaller units of data to result in significantly faster rates of computational speed.

### SUMMARY OF THE INVENTIVE CONCEPT

The present general inventive concept provides a lean framework computer system to provide optimal loading and processing of data sets and coding, the system that can comprise: a first map reduce processor to ingest the input data sets and coding, to convert the row-oriented data sets and coding into columnar-oriented data sets and coding, to split up the columnar-oriented data sets and coding into a plurality of smaller units, to load the split up columnar-oriented data sets and coding simultaneously in parallel, and to convert the columnar-oriented data sets and coding into an object-oriented language format; a memory to store the object-oriented language; and a second map reduce processor to receive the stored objects and configured to include a plurality of execution processors to split up the objects into a plurality of smaller units and parallel process the plurality of smaller units of objects simultaneously, and to reduce the parallel processed results into a final result according to programming included in the input coding.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a lean framework computer system to provide optimal loading and processing of data sets and coding, the system comprising: a first map reduce processor to ingest data sets and coding, to convert the row-oriented data sets and coding into a columnar-oriented format, to split up the columnar-oriented of data sets and coding into a plurality of smaller units, to load the split up columnar-oriented data sets and coding simultaneously in parallel, to reduce the loaded columnar-oriented data sets and coding, and to convert the loaded reduced columnar-oriented data sets and coding into an object-oriented language format; a memory to store the objects; and a second map reduce processor to receive the stored objects and configured to include a plurality of execution sub-processors to split up the objects into a plurality of smaller units and parallel process the plurality of smaller units of objects simultaneously, and to reduce the parallel processed results into a final result according to programming included in the input coding.

In an exemplary embodiment, the first map reduce processor can be configured to include: an extract-transform-load processor to convert the input data sets and coding into a columnar-oriented data sets and coding; a plurality of execution processors in parallel to split up the columnar-oriented data sets and coding into a plurality of smaller units, simultaneously load the plurality of smaller units and recombine the loaded plurality of smaller units of columnar-oriented data and coding; and a schema processor to transform the loaded recombined columnar-oriented data and coding into a objects.

The foregoing and/or other features and utilities of the present general inventive concept may also be achieved by providing a method of lean computational processing of row-oriented data sets, the method comprising: ingesting data sets and coding into a configured lean computer processor system; converting the row-oriented data sets and coding into columnar-oriented data sets and coding; splitting up the columnar-oriented data sets and coding into a plurality of smaller units; loading the split up columnar-oriented data sets and coding simultaneously in parallel; converting the columnar-oriented data sets and coding into an object-oriented language format; storing the objects in a memory; splitting up the objects stored in memory into a plurality of smaller units; parallel processing the plurality of smaller units of objects simultaneously; and reducing the parallel processed results into a final computational result according to the received coding.

The foregoing and/or other features and utilities of the present general inventive concept may also be achieved by providing a non-transient computer-readable storage medium containing programming code readable by a specially designed computing system configured to perform a process comprising: ingesting data sets and coding into a configured lean computer processor system; converting the row-oriented data sets and coding into columnar-oriented data sets and coding; splitting up the columnar-oriented data sets and coding into a plurality of smaller units; loading the split up columnar-oriented data sets and coding simultaneously in parallel; converting the columnar-oriented data sets and coding into an object-oriented language format; storing the objects in a memory; splitting up the objects stored in memory into a plurality of smaller units; parallel processing the plurality of smaller units of objects simultaneously; and reducing the parallel processed results into a final computational result according to the received coding.

### BRIEF DESCRIPTION OF THE DRAWINGS

These and/or other features and utilities of the present inventive concept will become apparent and more readily appreciated from the following description of the embodiments, taken in conjunction with the accompanying drawings of which:

FIG. 1 illustrates a lean framework computing system that performs specifically designed computational operations, according to an example embodiment of the present inventive concept;

FIG. 2 illustrates a process of performing lean computational operations, according to an example embodiment of the present inventive concept.

The drawings illustrate a few exemplary embodiments of the present inventive concept, and are not to be considered limiting in scope, as the overall inventive concept may admit to other equally effective embodiments. The elements and features shown in the drawings are to scale and attempt to clearly illustrate the principles of exemplary embodiments of the present inventive concept. In the drawings, reference numerals designate like or corresponding, but not necessarily identical, elements throughout the several views.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures. Also, while describing the present general inventive concept, detailed descriptions about related well-known functions or configurations that may diminish the clarity of the points of the present general inventive concept are omitted.

It will be understood that although the terms “first” and “second” are used herein to describe various elements, these elements should not be limited by these terms. These terms are only used to distinguish one element from another element. Thus, a first element could be termed a second element, and similarly, a second element may be termed a first element without departing from the teachings of this disclosure.

Expressions such as “at least one of,” when preceding a list of elements, modify the entire list of elements and do not modify the individual elements of the list.

All terms including descriptive or technical terms which are used herein should be construed as having meanings that are obvious to one of ordinary skill in the art. However, the terms may have different meanings according to an intention of one of ordinary skill in the art, case precedents, or the appearance of new technologies. Also, some terms may be arbitrarily selected by the applicant, and in this case, the meaning of the selected terms will be described in detail in the detailed description of the invention. Thus, the terms used herein should be defined based on the meaning of the terms together with the description throughout the specification.

Also, when a part “includes” or “comprises” an element, unless there is a particular description contrary thereto, the part can further include other elements, not excluding the other elements. In the following description, terms such as “unit” and “module” indicate a unit to process at least one function or operation, wherein the unit and the block may be embodied as hardware or software or embodied by combining hardware and software.

Hereinafter, one or more exemplary embodiments of the present general inventive concept will be described in detail with reference to accompanying drawings.

Exemplary embodiments of the present general inventive concept are directed to a system which converts data received in a first format into a simplified lean framework that vastly reduces computation time. A more detailed description of the inventive concept is provided below.

In the past several years, a vast number of open-source data formats have been designed to support the needs of various computing and data management applications. These formats can be provided in row or column-oriented formats, and they can support various forms of serialization and compression. Columnar-oriented storage is a type of storage of files where data is stored by columns, not by rows. Parquet and Optimized Row Column (ORC) files are examples of columnar file formats. Columnar storage can significantly reduce the amount of data required to be fetched from a disk by allowing access to only the columns that are relevant for a particular query or workload. Moreover, columnar storage, combined with efficient encoding and compression techniques, can drastically reduce the storage space requirements without sacrificing query performance.

The present inventive concept provides a uniquely structured lean framework of a computing system which causes a computing system to restructure data received in a first format into a columnar-oriented format, which results in vastly reducing the loading speed of the data, as well as vastly reducing computation times of the data, and vastly reducing the required amount of storage space for the data, thus providing significant time savings and cost benefits.

Large amounts of data and/or data sets are generally received by a computing system in a “comma separated values” (CSV) format. Loading times as well as analytical computations of such data sets are generally hindered (i.e., slowed down) by a plurality of congested processes, which are not streamlined for optimized loading or computing operations. As a result, these loading and computation processes take inordinately long durations of time to perform to completion. Further, the data and/or data sets that are processed generally require a significant amount of storage space for storage and/or buffering.

It is to be noted that data sets are defined herein as a collection of related sets of information that are composed of separate elements that can be manipulated as a unit by a computer, while coding is provided to perform instructional tasks (aka functions) on the data sets.

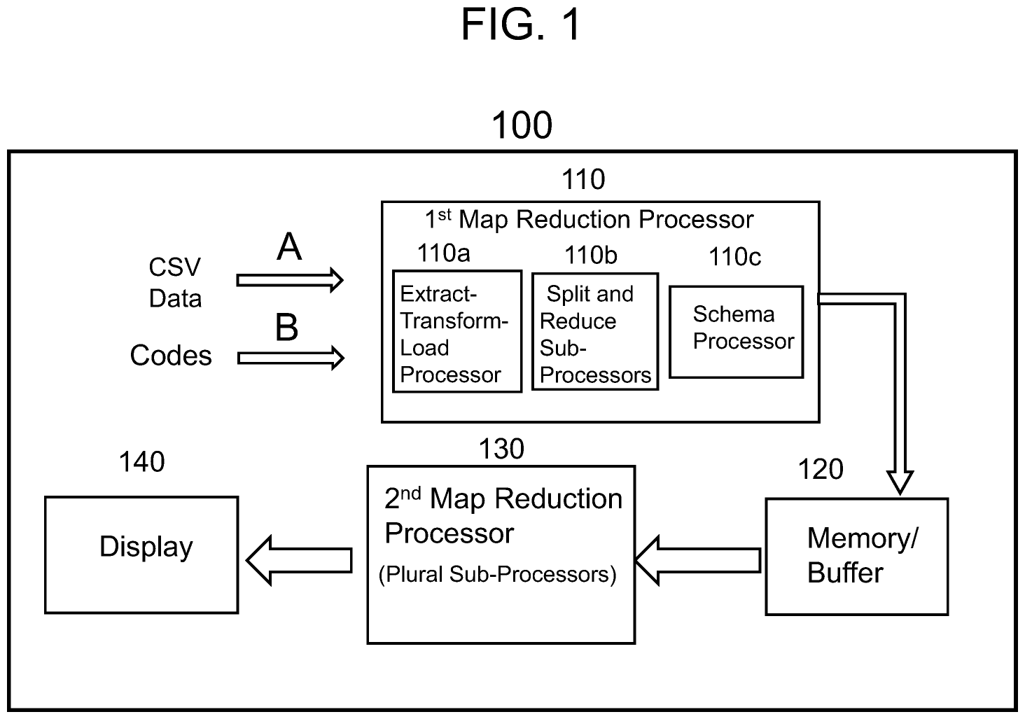

Referring to FIG. 1, in accordance with an example embodiment of the present inventive concept, a lean framework computing system 100 is configured to optimize both loading speeds and computing operations on input data sets and coding (or programming functions) by restructuring the data sets and coding into a columnar-oriented format (i.e., Parquet and ORC file formats; but not limited thereto), splitting up the data sets and coding for parallel processing to vastly increase loading speeds, performing a plurality of parallel loading computations on the columnar-oriented data, reducing the loaded data back to a singular unit, transforming the reduced loaded columnar-oriented data to an object-oriented language, splitting up the objects into a plurality of smaller units, performing execution processes on the plurality of smaller units simultaneously and in parallel, and reducing the plurality of parallel computations to an end result according to the ingested coding.

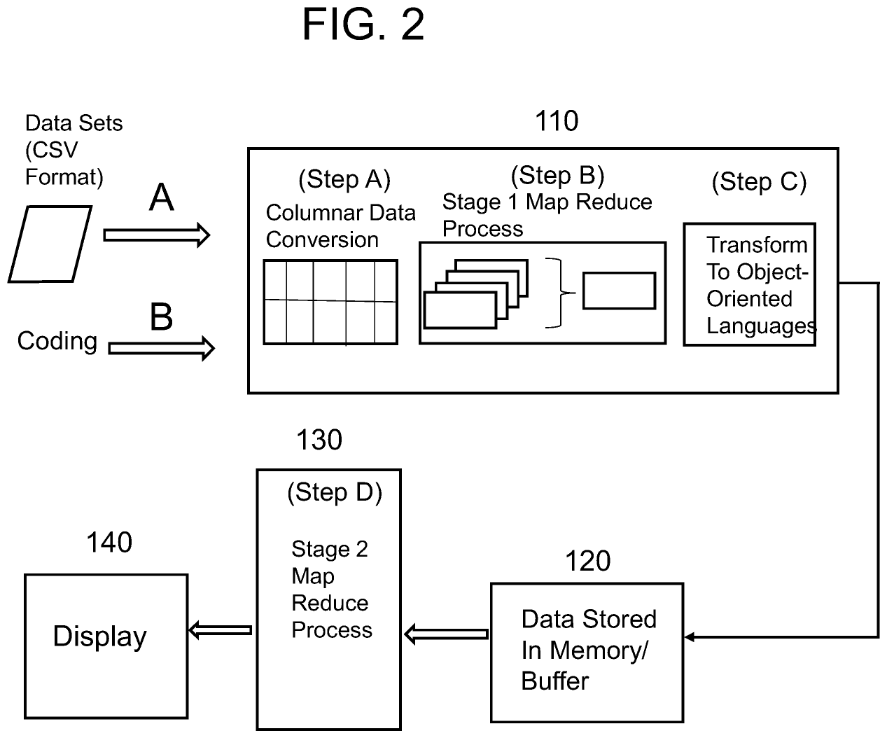

By performing the plurality of operations listed above, the lean framework computing system 100 according to the example embodiment of FIGS. 1 and 2, can vastly reduce the loading time of ingested data sets and coding into the lean framework computing system 100, and can vastly reduce the computation times required to obtain the intended results instructed by the ingested coding.

Still referring to FIG. 1, the lean framework computing system 100 can include a first map reduce processor 110, a memory 120, a second map reduce processor 130, and a display unit 140. The first map reduce processor 110 can be configured to include an extract-transform-load processor 110a, a plurality of parallel execution processors 110b, and a schema processor 110c, which will each be described in more detail below. The memory/buffer 120, a second map reduce processor 130 and a display unit 140 will also be described in more detail below.

FIG. 2 illustrates a plurality of process steps performed by each of the first map reduce processor 110, the memory 120, the second map reduce processor 130, and the display unit 140, according to an example embodiment of the present inventive concept.

Referring to FIGS. 1 and 2, data or data sets (A) and coding (programming functions) (B) can be ingested into the lean framework computing system 100 to perform a plurality of computational processes to obtain desired results, wherein the desired results are generally instructed by the coding input therein (input B).

It is well known that data and data sets, are generally provided in a CSV format (i.e., row-oriented format). The first map reduce processor 110 can ingest the input data sets and coding in a row-oriented (CSV) format. The extract-transform-load processor 110a can then transform the received CSV formatted data sets and coding into a columnar-oriented format, such as, for example, a Parquet file format or ORC file format (FIG. 2, Step A). It is well known that column formatted storage files are more lightweight, as adequate compression can be performed for each column, and column formatted storage files are more efficient in reading the data in less time, and reduce latency of the data.

The columnar formatted data sets (i.e., Parquet format) can be split up into a plurality of smaller units, loaded in parallel through a plurality of execution processors and then reduced back to a combined form by the plurality of execution sub-processors 110b included in the first map reduce processor 110. More specifically, the plurality of execution sub-processors 110b can be configured to split up input data sets into smaller units, load the split-up units simultaneously and in parallel, and recombine the loaded units. This first stage of the map reduce process (FIG. 2, Steps A-B) performed by the first map reduce processor 110 results in a higher speed of loading large amounts of data by transforming the data into a columnar-oriented format, splitting up the data sets into smaller units, and loading the smaller units simultaneously in parallel through a plurality of separate loading sub-processors.

The first map reduce processor 110 can also transform the loaded columnar-oriented data sets into an object-oriented language format with the assistance of the schema processor 110c configured therein. Object-oriented languages are higher level syntaxes, which combine the data sets into a structure called an object. Some examples of object-oriented language programming are C++, Java, Python, etc. An object in object-oriented language can contain data, in the form of fields, and codes in the form of procedures. These procedures could include, for example, time series calculations, calculations for a mortgage loan, etc., but are not limited thereto, and can be any type of structured procedures for the transformation of objects. A loan object, for example, would then look to describe all properties relevant to the loan (or other type of structured data). These objects are structurally interpreted by higher level syntaxes, or programming languages, with a way to perform complex computations. In other words, object-oriented language is a high-level computer programming language that implements objects and their associated procedures within the programming context to create software programs.

The object-oriented languages leverage structured data so that subroutines can be performed on the data. The subroutines are generally single functions, such as, for example, loops, the addition of two or more numbers, etc. When these subroutines are chained together in a specific sequence they can perform more complex operations, relevant in large analytical contexts. The subroutines can be performed as part of larger complex engines for analytical processing within a map reduce processor, as is described in more detail below.

The objects can be stored in the memory/buffer 120 to be forwarded to the second map reduce processor 130 for further processing. In other words, the memory 120 can act as a buffer to store the data while the data is being ingested into a second map reduce processor 130.

The second map reduce processor 130 is configured to include a plurality of execution sub-processors which can simultaneously perform programmed computations in parallel (FIG. 2, Step D). The second map reduce processor 130 is also configured to split up the object-oriented data into smaller units, wherein the split-up units of the object-oriented data can be simultaneously fed into respective ones of the plurality of parallel execution sub-processors configured within the second map reduce processor 130. The parallel execution sub-processors can then perform programmed computations simultaneously on the units of object-oriented data based on the coding included in the object-oriented language. The programmed computations that are performed by the plurality of execution sub-processors can be computational tasks included in the ingested coding (B).

By adding a second layer of map-reduction operations (FIG. 2, Step D), the elimination of a single, vastly complex process to be performed on data can be avoided, lending far more control over computations performed by the map reduce processors 110 and 130. The results of the computations performed by the second map reduce processor 130, once available, can then be provided to service protocols for subsequently displaying the results, or forwarding the computational results for other computational tasks. In other words, end operations can then be performed with protocols that can service other purposes.

Performance improvements enabled by the present inventive concept as described herein include the following: a single core processor having, for example, ten partitions of data (i.e., ingestion of multiple data sets and functions split up into, i.e., ten units of data, as illustrated in FIG. 1) consuming 1 GB of raw data in CSV format, including two stages of map reduce processors 110 and 130, utilizing 2 GBs of RAM, can produce complex computational results in under fifteen seconds duration. The single core processor in this example embodiment is benchmarked at 1.33 GHz and is dedicated. These results are reproducible in both on-premise infrastructure and cloud native infrastructure, and is a more than 70% improvement in loading and processing of data sets as compared to traditional non-map-reduced computer processors or single stage map-reduce processors.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A lean framework computer system to provide optimal loading and processing of data sets and coding, the system comprising:
a first map reduce processor to ingest data sets and coding, to convert the row-oriented data sets and coding into a columnar-oriented format, to split up the columnar-oriented of data sets and coding into a plurality of smaller units, to load the split up columnar-oriented data sets and coding simultaneously in parallel, to reduce the loaded columnar-oriented data sets and coding, and to convert the loaded reduced columnar-oriented data sets and coding into an object-oriented language format;
a memory to store the object-oriented language; and
a second map reduce processor to receive the stored object-oriented language and configured to include a plurality of execution sub-processors to split up the object-oriented language into a plurality of smaller units and parallel process the plurality of smaller units of object-oriented language simultaneously, and to reduce the parallel processed results into a final result according to programming included in the input coding.

2. The system according to claim 1, wherein the first map reduce processor is configured to include:
an extract-transform-load processor to convert the input data sets and coding into a columnar-oriented data sets and coding;
a plurality of execution processors in parallel to split up the columnar-oriented data sets and coding into a plurality of smaller units, simultaneously load the plurality of smaller units and recombine the loaded plurality of smaller units of columnar-oriented data and coding; and
a schema processor to transform the loaded recombined columnar-oriented data and coding into an object-oriented language.

3. A method of lean computational processing of row-oriented data sets, the method comprising:
ingesting data sets and coding into a configured lean computer processor system;
converting the row-oriented data sets and coding into columnar-oriented data sets and coding;
splitting up the columnar-oriented data sets and coding into a plurality of smaller units;
loading the split up columnar-oriented data sets and coding simultaneously in parallel;
converting the columnar-oriented data sets and coding into an object-oriented language format;
storing the object-oriented language in a memory;
splitting up the object-oriented language stored in memory into a plurality of smaller units;
parallel processing the plurality of smaller units of object-oriented language simultaneously; and
reducing the parallel processed results into a final computational result according to the received coding.

4. A non-transient computer-readable storage medium containing programming code readable by a specially designed computing system configured to perform a process comprising:
ingesting data sets and coding into a configured lean computer processor system;
converting the row-oriented data sets and coding into columnar-oriented data sets and coding;
splitting up the columnar-oriented data sets and coding into a plurality of smaller units;
loading the split up columnar-oriented data sets and coding simultaneously in parallel;
converting the columnar-oriented data sets and coding into an object-oriented language format;
storing the object-oriented language in a memory;
splitting up the object-oriented language stored in memory into a plurality of smaller units;
parallel processing the plurality of smaller units of object-oriented language simultaneously; and
reducing the parallel processed results into a final computational result according to the received coding.
